(19) United States
(12) Patent Application Publication
(10) Pub. No.: US 2025/0383583 A1
(43) Pub. Date: Dec. 18, 2025

(54) CAMERA STRUCTURE

(71) Applicant: Luxshare Intelligent Manufacture Technology (Changshu) Co., Ltd, Changshu City (CN)

(72) Inventors: Po-Ying TSENG, Taipei City (TW); Li-Jhen CHEN, Taipei City (TW)

(73) Assignee: Luxshare Intelligent Manufacture Technology (Changshu) Co., Ltd, Changshu City (CN)

(21) Appl. No.: 19/236,217

(22) Filed: Jun. 12, 2025

(30) Foreign Application Priority Data
Jun. 13, 2024 (CN) 2024107609029

(51) Int. Cl. G03B 5/00; G02B 27/64; G03B 13/36

(52) U.S. Cl. CPC G03B 5/00; G02B 27/646; G03B 13/36; G03B 2205/0007

(57) ABSTRACT

A camera structure includes a moving structure and a camera lens. The moving structure includes first moving portion, second moving portion and moving element. The moving element is sphere and is disposed between the first moving portion and the second moving portion. The first moving portion has a first plane and a first surface. The second moving portion has second plane and second surface. The first plane and second plane are parallel to each other. The moving element touches against the first surface at the first contact point. The moving element touches against the second surface at the second contact point. The first contact point and the second contact point is located at two side of the moving element. The moving element moves along the first surface of the first moving portion and the second surface of the second moving portion. The camera lens is displaced through the moving structure.

### CROSS REFERENCE TO RELATED APPLICATION

This application claims the priority benefit of Chinese Patent Application Serial Number 2024107609029, filed on Jun. 13, 2024, the full disclosure of which is incorporated herein by reference.

### BACKGROUND

### 1. Technical Field

The present application relates to the technical field of camera technology, particularly to a camera structure.

### 2. Description of the Related Art

Camera devices often feature anti-shake mechanisms to enhance image stability. When a user holds the camera for capturing images, unsteady shaking or vibrations can negatively impact the quality of the images. Optical image stabilization technology helps counteract these effects, leading to clearer, high-quality images.

### SUMMARY

A camera structure includes: a moving structure and a camera lens. The moving structure includes a first moving portion, a second moving portion and a moving element. The moving element is disposed between the first moving portion and the second moving portion, wherein the moving element is a sphere. The first moving portion has a first plane and a first surface. The first plane extends to connect to the first surface; the first surface and the first plane form an angle greater than ninety degrees. The second moving portion has a second plane and a second surface. The second plane extends to connect to the second surface; the second surface and the second plane form an angle greater than ninety degrees. The first plane and the second plane are parallel to each other. The moving element touches against the first surface at the first contact point, the moving element touches against the second surface at the second contact point. The first contact point and the second contact point is located at two sides of the moving element respectively. The line connecting the first contact point and the second contact point passes through the center of the moving element, the first moving portion and the second moving portion are configured to move relative to each other. The moving element is configured to moves on the first surface and the second surface; and the camera lens configured to move through the moving structure.

In one embodiment of the present application, the moving structure includes a first protrusion and a second protrusion. The first protrusion protrudes from the first plane toward the second plane, the first surface is located on the first protrusion; the second protrusion protrudes from the second plane toward the first plane, and the second surface is located on the second protrusion.

In one embodiment of the present application, the first protrusion comprises a first top surface, the second protrusion comprises a second top surface, the first top surface and the first plane are parallel to each other, and the second top surface and the second plane are parallel to each other.

In one embodiment of the present application, the first protrusion comprises a first top surface, the second protrusion comprises a second top surface, the first top surface and the second plane are spaced apart from each other, and the second top surface and the first plane are spaced apart from each other.

In one embodiment of the present application, a minimum distance between the first top surface and the second plane is less than the diameter of the moving element. A minimum distance between the second top surface and the first plane is less than the diameter of the moving element.

In one embodiment of the present application, the camera structure further comprises a base assembly and a first moving assembly. The first moving assembly is located within the base assembly. The moving structure comprises a first moving structure. The first moving structure is provided between an inner wall of the base assembly and an outer wall of the first moving assembly corresponding to the inner wall of the base assembly. The base assembly has the first moving portion, the first moving assembly has the second moving portion, the first moving structure is configured to guides the first moving assembly to perform a reciprocating movement toward a first direction relative to the base assembly.

In one embodiment of the present application, the base assembly comprises a base and a first coil. The first coil is disposed on the base. The first moving assembly comprises a first moving body and a first magnet. The first magnet is disposed on the first moving body. The first coil is corresponds to the first magnet and a magnetic pole direction of the first magnet is parallel to the first direction.

In one embodiment of the present application, the base has an accommodation concave slot and a recessed side wall of the accommodation concave slot has a first notch. The first coil is located in the first notch. The first moving body has a first accommodation trough and the first magnet dispose in the first accommodation trough. A location of the first notch is corresponds to a location of the first accommodation trough.

In one embodiment of the present application, the camera structure further includes a second moving assembly. The moving structure comprises a second moving structure. The second moving assembly is disposed within the first moving assembly. The second moving structure is provided between a top portion of the first moving assembly and a bottom portion of the second moving assembly. The first moving assembly has the first moving portion and the second moving assembly has the second moving portion. The second moving structure is configured to guides the second moving assembly to perform a reciprocating movement toward a second direction relative to the first moving assembly, and the second direction is perpendicular to and the first direction.

In one embodiment of the present application, the camera structure further comprises a lens base assembly and the moving structure comprises a third moving structure. The lens base assembly is disposed on the second moving assembly. The third moving structure is provided between a top portion of the second moving assembly and a bottom portion of the lens base assembly. The second moving assembly has the first moving portion. The lens base assembly has the second moving portion. The third moving structure is configured to guides the lens base assembly to perform a reciprocating movement toward a third direction relative to the second moving assembly. The third direction is perpendicular to the second direction.

In one embodiment of the present application, the camera lens is disposed on the lens base assembly.

In one embodiment, the base assembly comprises a base and a second coil. The second coil is disposed on the base. The lens base assembly comprises a lens base and a second magnet. The second magnet is disposed on the lens base and the second magnet is corresponds to the second coil. A magnetic pole direction of the second magnet is parallel to the second direction.

In one embodiment of the present application, the base has an accommodation concave slot and a recessed side wall of the accommodation concave slot further has a second notch. The second coil is located in the second notch. The lens base has a second accommodation trough and the second magnet dispose in the second accommodation trough. A location of the second notch is corresponds to a location of the second accommodation trough.

In one embodiment of the present application, the base assembly comprises a base and a third coil. The third coil is disposed on the base. The lens base assembly comprises a lens base and a third magnet. The third magnet is disposed on the lens base and the third magnet is corresponds to the third coil. A magnetic pole direction of the third magnet is parallel to the third direction.

In one embodiment of the present application, the base has an accommodation concave slot and a recessed side wall of the accommodation concave slot further comprises a third notch. The third coil is located in the third notch. The lens base has a third accommodation trough and the third magnet is disposed in the third accommodation trough. A location of the third notch is corresponds to a location of the third accommodation trough.

In one embodiment of the present application, the camera structure further comprises a spring plate, spring plate is disposed on the first moving assembly, and the spring plate presses against the top of the lens base assembly.

In one embodiment of the present application, the spring plate is arranged along a side of the first moving assembly, and a fixing part extends downward from the side of the spring plate. The first moving assembly has a fixed trough corresponding to the fixing part. The fixing part of the spring plate is correspondingly fixed in the fixed trough of the first moving assembly.

In one embodiment of the present application, the camera structure further includes a circuit board. The circuit board is arranged around the base assembly. The circuit board is electrically connected to the first coil, the second coil and the third coil, respectively.

In one embodiment of the present application, the first surface is parallel to the second surface, and the first plane and the second plane are inclined planes or correspondingly curved surfaces.

The present application provides a camera structure in which the moving element touches against the first surface of the first moving portion at first contact point; the moving element touches against the second surface of the second moving portion at the second contact point. The first contact point and the second contact point respectively are located on two sides of the moving element. The moving element moves along the first surface of the first moving portion and the second surface of the second moving portion. In this embodiment, the moving element is assembled between the first moving portion and the second moving portion. The moving element is supported by symmetrical contact points from the first moving portion and the second moving portion. This configuration reduces the sliding friction of the moving element relative to the first moving portion and the second moving portion, thereby decreasing the movement restriction imposed by the first moving portion and the second moving portion on the moving element.

### BRIEF DESCRIPTION OF THE DRAWINGS

The accompanying drawings described here are provided to facilitate a further understanding of the present application and constitute a part of this application. The illustrative embodiments and their descriptions are used to explain the present application and do not constitute undue limitations on it. In the drawings:

FIG. 1 is a perspective view of the camera structure of the present application;

FIG. 2 is a sectional view along line A-A′ of FIG. 1;

FIG. 3 is an enlarged view of area D in FIG. 2;

FIG. 4 is a sectional view along line B-B′ of FIG. 1;

FIG. 5 is a sectional view along line C-C′ of FIG. 1;

FIG. 6 is an exploded perspective view of the camera structure of the present application;

FIG. 7 is a partially exploded perspective view of the camera structure of the present application;

FIG. 8 is an enlarged view of area E in FIG. 7;

FIG. 9 is another partially exploded perspective view of the camera structure of the present application;

FIG. 10 is yet another partially exploded perspective view of the camera structure of the present application;

FIG. 11 is a schematic view of another embodiment of the moving structure of the present application; and

FIG. 12 is a schematic view of yet another embodiment of the moving structure of the present application.

1: camera structure;
11, 11A, 11B, 11C: moving structure;
111, 111A, 111B, 111C, 111D, 111E: first moving portion;
1111, 1111A, 1111B, 1111C, 1111D, 1111E: first plane;
1112, 1112A, 1112B, 1112C, 1112D, 1112E: first surface;
112, 112A, 112B, 112C, 112D, 112E: second moving portion;
1121, 1121A, 1121B, 1121C, 1121D, 1121E: second plane;
1122, 1122A, 1122B, 1122C, 1122D, 1122E: second surface;
113, 113A, 113B, 113C, 113D, 113E: moving element;
114: first protrusion;
1141: first top surface;
115: second protrusion;
1151: second top surface;
12: camera lens;
13: base assembly;
131: base;
1310: accommodation concave slot;
1311: first notch;
1312: second notch;
1313: third notch;
132: first coil;
133: second coil;
134: third coil;
14: first moving assembly;
141: first moving body;
1411: first accommodation trough;
142: first magnet;
143: fixed trough;
15: second moving assembly;
16: lens base assembly;
161: lens base;
1611: second accommodation trough;
1612: third accommodation trough;
162: second magnet;
163: third magnet;
17: circuit board;
18: spring plate;
181: fixing part;
19: protective cover;
191: orifice;
1P: first contact point;
2P: second contact point;
Z: first direction;
Y: second direction;
X: third direction.

### DETAILED DESCRIPTION OF THE EMBODIMENTS

The following drawings disclose multiple embodiments of the present application. For the sake of clarity, many implementation details will be described in the following narration. However, it should be understood that these implementation details should not be used to limit the present application. That is to say, in some embodiments of the present application, these implementation details are not essential. Additionally, for the sake of simplicity in the drawings, some conventional structures and components will be illustrated in a simplified and schematic manner. In the following embodiments, the same reference numerals will be used to denote the same or similar components.

In prior art, traditional systems of a camera typically employ a ball-type anti-shake design, where balls roll within a V-shaped groove. Over time, the multiple contact points between the balls and the groove can cause significant friction, leading to issues such as debris accumulation, dirt, and contamination.

One of embodiments of the present application provides a camera structure that uses rolling of a moving element with a first moving portion and a second moving portion to address the issue of excessive friction caused by multiple contact points in conventional ball-based designs.

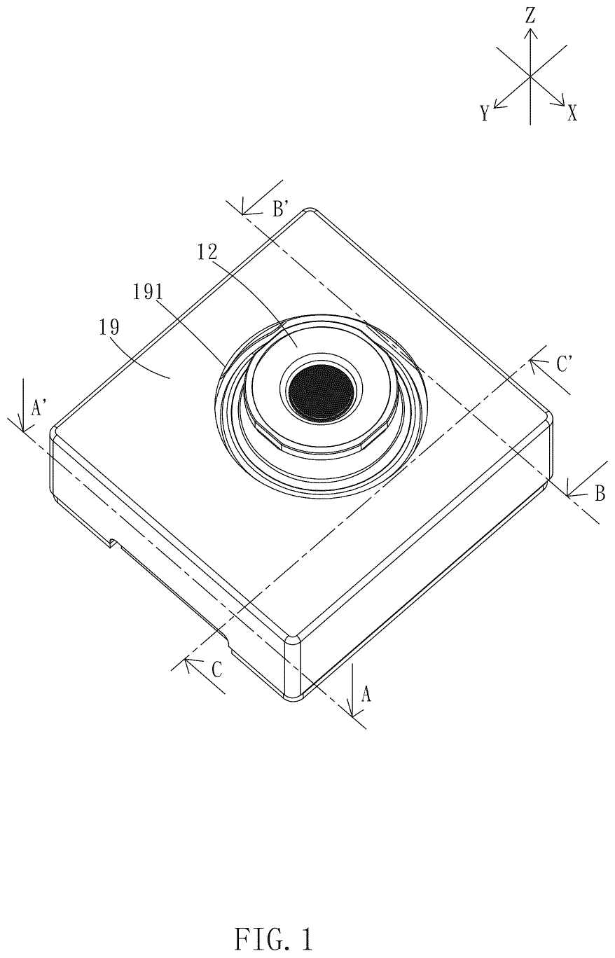

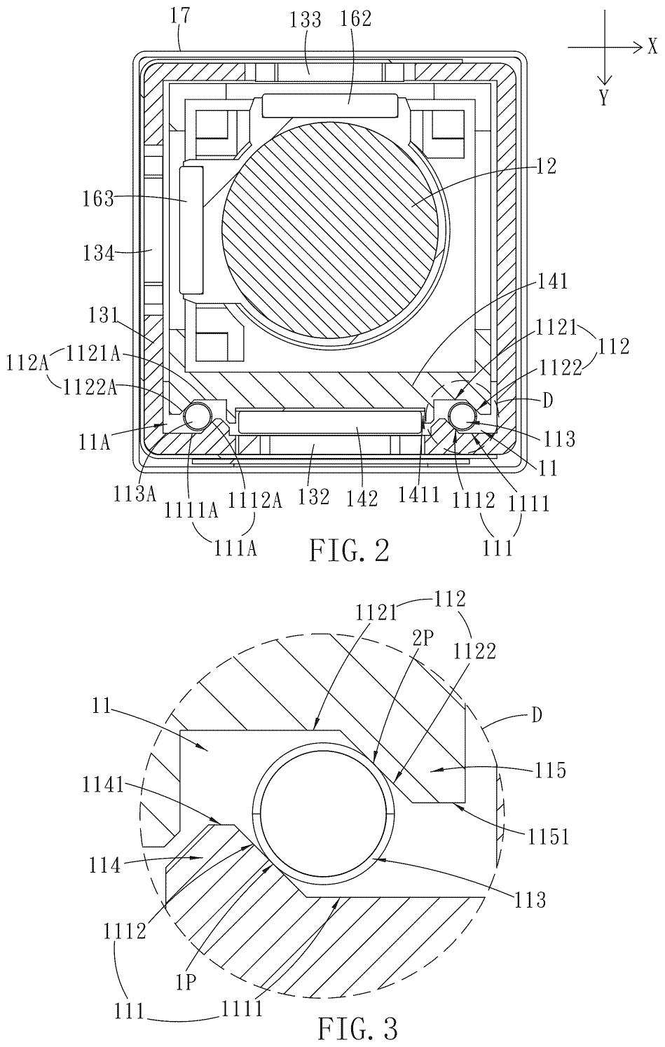

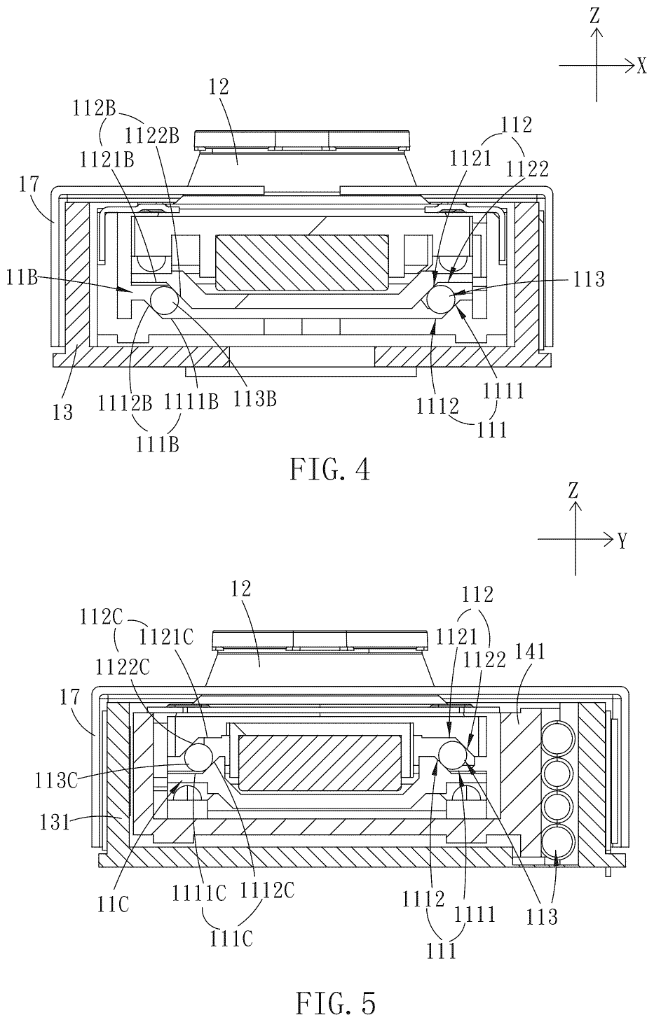

Please refer to FIG. 1 to FIG. 5, FIG. 1 is a perspective view of the camera structure of the present application, FIG. 2 is a sectional view along line A-A′ of FIG. 1, FIG. 3 is an enlarged view of area D in FIG. 2, FIG. 4 is a sectional view along line B-B′ of FIG. 1 and FIG. 5 is a sectional view along line C-C′ of FIG. 1. As shown in FIG. 1 to FIG. 5, the present application provides a camera structure 1 includes a moving structure 11 and a camera lens 12. The moving structure 11 includes a first moving portion 111, a second moving portion 112 and a moving element 113. The moving element 113 is disposed between the first moving portion 111 and the second moving portion 112, wherein the moving element 113 is a sphere. The first moving portion 111 has a first plane 1111 and a first surface 1112. The first plane 1111 extends to connect to the first surface 1112. The first surface 1112 and the first plane 1111 have an included angle exceeding ninety degree. The second moving portion 112 has a second plane 1121 and a second surface 1122. The second plane 1121 extends to connect to the second surface 1122. The second surface 1122 and the second plane 1121 have an included angle exceeding ninety degrees. The first plane 1111 is parallel to the second plane 1121. The moving element 113 touches against the first surface 1112 at the first contact point 1P. The moving element 113 touches against the second surface 1122 at the second contact point 2P. The first contact point 1P and the second contact point 2P is located at two sides of the moving element 113 respectively. The line connecting the first contact point 1P and the second contact point 2P passes through the center of the moving element 113. The first moving portion 111 and the second moving portion 112 move relative to each other. The moving element 113 moves on the first surface 1112 and the second surface 1122. The camera lens 12 is displaced through the moving structure 11. In some embodiments, the moving structure 11 provides the camera lens 12 with the function of auto-focus (AF) and/or optical image stabilization (OIS).

Please refer to FIG. 3, in this embodiment, the moving structure 11 rolls between the first surface 1112 of the first moving portion 111 and the second surface 1122 of the second moving portion 112 through the moving element 113. This arrangement prevents the moving element 113 from making extensive contact with different surfaces, thereby reducing excessive frictional wear between the first surface 1112 of the first moving portion 111 and the second surface 1122 of the second moving portion 112 in relation to the moving element 113. Furthermore, the moving element 113 has two contact points relative to the first moving portion 111 and the second moving portion 112. This allows for easier control of the dimensions and tolerances between the moving element 113 and the two contact surfaces, making it easier to accurately predict the contact situation at each position. Additionally, because the moving speed of the moving element 113 relative to the first contact point 1P and the second contact point 2P is close to or the same, and the rotational radii of the contact positions at the first contact point 1P and the second contact point 2P are close to or the same, the rotation angular velocity of the moving element 113 will be close to or the same. This reduces the likelihood of sliding friction occurring in the moving element 113, thereby extending its lifespan through this technical means and effect.

In some embodiments, the moving structure 11 includes a first protrusion 114 and a second protrusion 115. The first protrusion 114 protrudes from the first plane 1111 toward the second plane 1121. The first surface 1112 is located on the first protrusion 114. The second protrusion 115 protrudes from the second plane 1121 toward the first plane 1111. The second surface 1122 is located on the second protrusion 115. The moving element 113 is surrounded and constrained by the first protrusion 114, the first plane 1111, the second protrusion 115 and the second plane 1121. In some embodiments, the first protrusion 114 includes a first top surface 1141 and the second protrusion 115 includes a second top surface 1151. The first top surface 1141 is parallel to the first plane 1111. The second top surface 1151 is parallel to the second plane 1121. In some embodiments, the first top surface 1141 and the second plane 1121 are spaced apart without touching each other. The second top surface 1151 and the first plane 1111 are spaced apart without touching each other.

In some embodiments, a minimum distance between the first top surface 1141 and the second plane 1121 is less than the diameter of the moving element 113. A minimum distance between the second top surface 1151 and the first plane 1111 is less than the diameter of the moving element 113. The following explains the distance between the first top surface 1141 and the second plane 1121 in relation to the moving element 113. If the space between the first top surface 1141 and the second plane 1121 is equidistant, then the moving element 113 is restricted and cannot move between the first top surface 1141 and the second plane 1121. If the space between the first top surface 1141 and the second plane 1121 is not equidistant, the minimum distance between the first top surface 1141 and the second plane 1121 is less than the diameter of the moving element 113, and the maximum distance between the first top surface 1141 and the second plane 1121 does not necessarily need to be greater or less than the diameter of the moving element 113. Furthermore, if the maximum distance between the first top surface 1141 and the second plane 1121 is greater than the diameter of the moving element 113, it indicates that the moving element 113 can move further between the first top surface 1141 and the second plane 1121. A part of the first top surface 1141 and the second plane 1121 can also serve as guides and constraints for the moving element. However, the moving range of the moving element 113 will still be limited by the minimum distance between the first top surface 1141 and the second plane 1121. This ensures that the moving element 113 cannot move out through the gap between the first top surface 1141 and the second plane 1121 or the gap between the second top surface 1151 and the first plane 1111. This design prevents moving element 113 from escaping between the first moving portion 111 and the second moving portion 112. Additionally, the distance between the second top surface 1151 and the first plane 1111 is the same as the aforementioned distance between the first top surface 1141 and the second plane 1121, so it will not be repeated here.

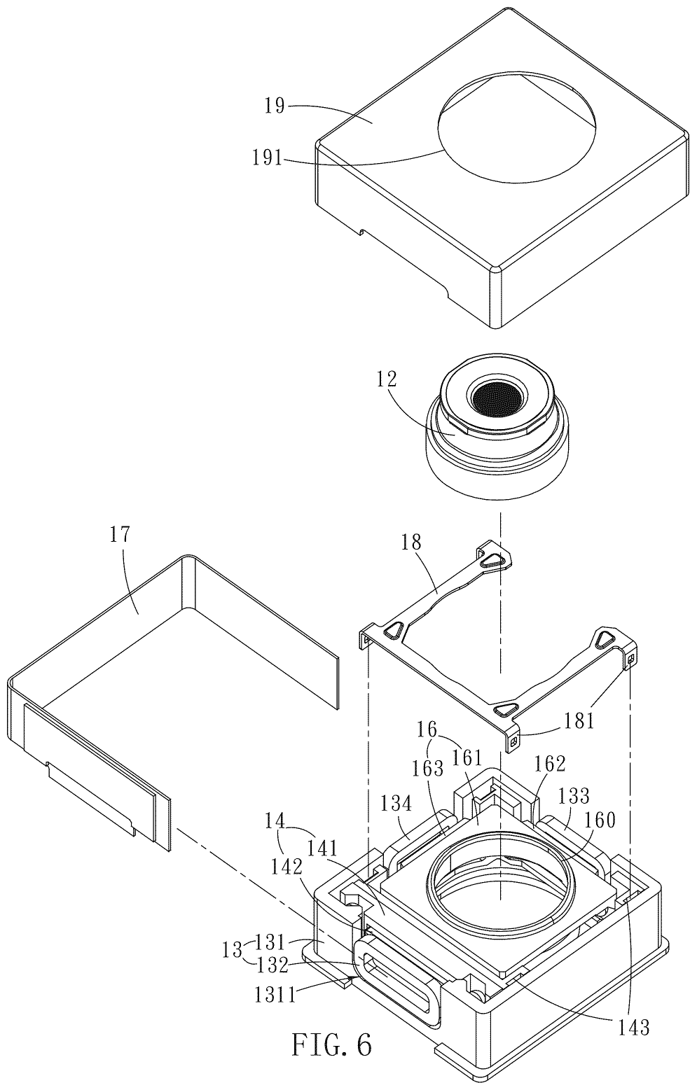

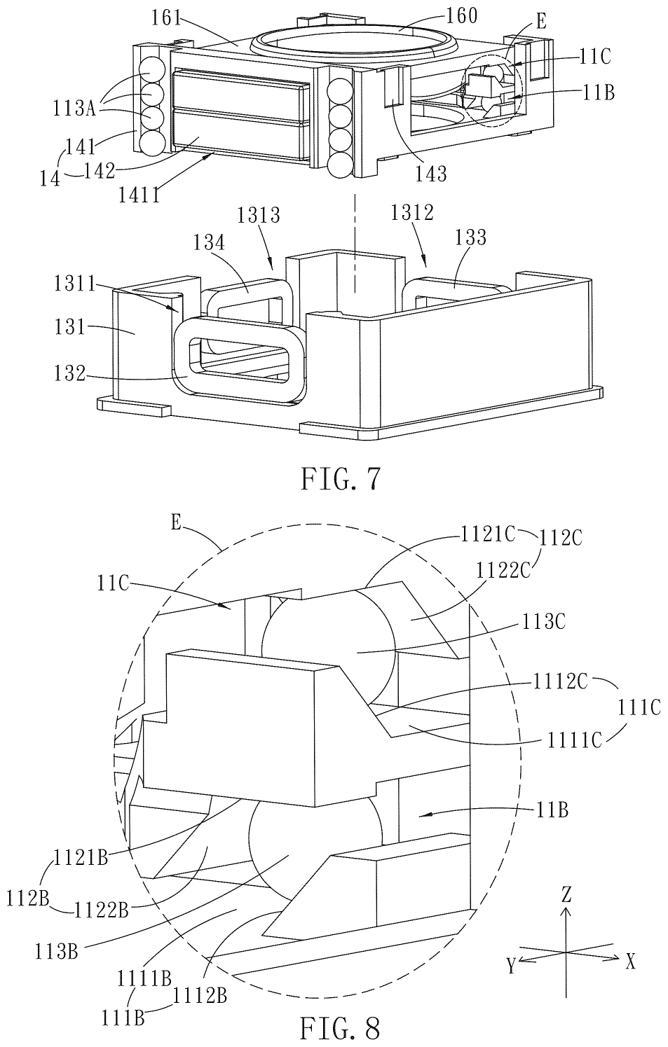

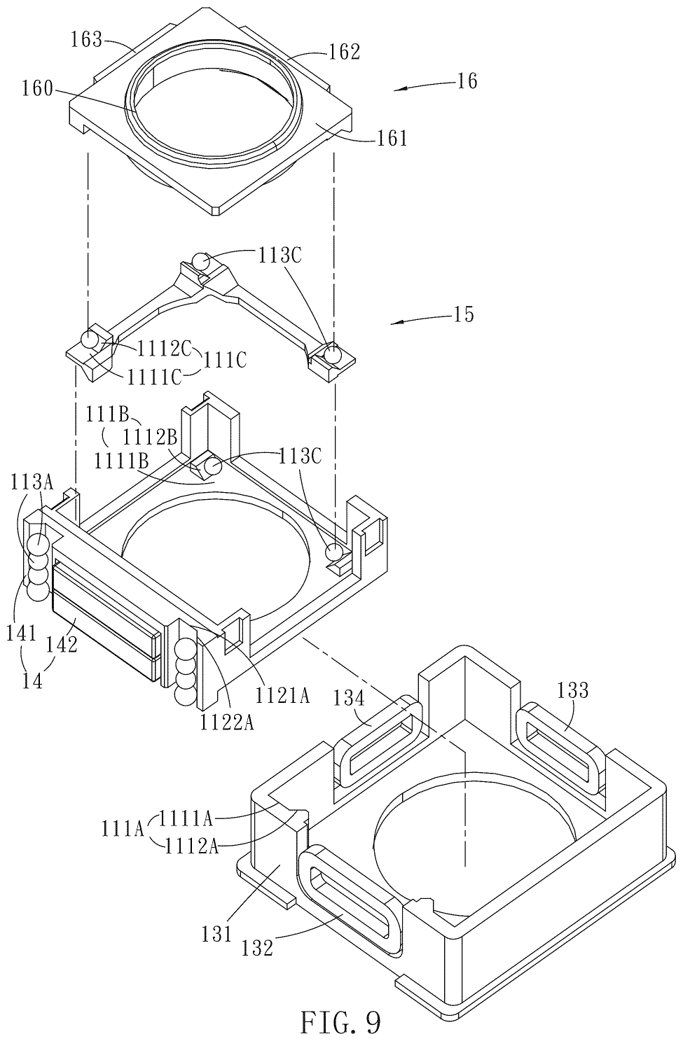

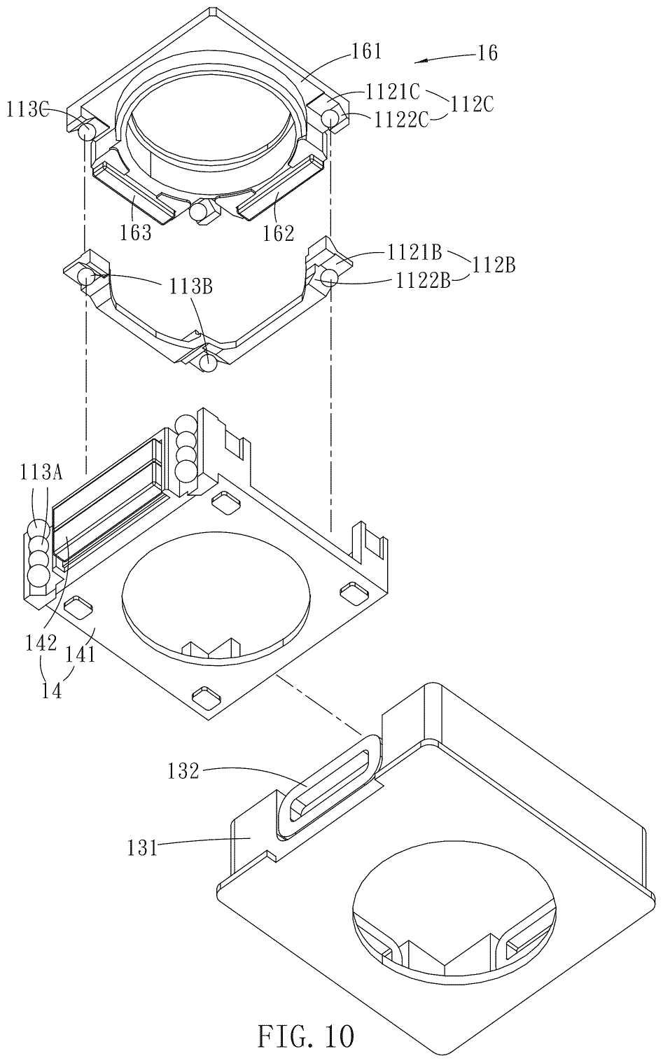

Please refer to FIG. 6 to FIG. 10, FIG. 6 is an exploded perspective view of the camera structure of the present application, FIG. 7 is a partially exploded perspective view of the camera structure of the present application, FIG. 8 is an enlarged view of area E in FIG. 7, FIG. 9 is another partially exploded perspective view of the camera structure of the present application and FIG. 10 is yet another partially exploded perspective view of the camera structure of the present application. As shown in FIG. 6 to FIG. 10, in this embodiment, the camera structure 1 further includes a base assembly 13 and a first moving assembly 14. The first moving assembly 14 is located within the base assembly 13. The moving structure 11 includes a first moving structure 11A, with the first moving portion 111A is located between the inner wall of the base assembly 13 and the outer wall of the first moving assembly 14, corresponding to the inner wall of the base assembly 13. The base assembly 13 has a first moving portion 111A, and the first moving assembly 14 has a second moving portion 112A. A moving element 113A is located between the first moving portion 111A and the second moving portion 112A. In this embodiment, multiple moving element 113 are arrange along the first direction Z between the base assembly 13 and the first moving assembly 14. The first moving structure 11A guides the first moving assembly 14 to perform a reciprocating movement toward the first direction Z (i.e. vertical direction) relative to the base assembly 13. The first plane 1111A of the first moving portion 111A of the base assembly 13 is parallel to the second plane 1121A of the second moving portion 112A of the first moving assembly 14. Regarding the first plane 1111A and the second plane 1121A, the first surface 1112A of the first moving portion 111A of the base assembly 13 and the second surface 1122A of the second moving portion 112A of the first moving assembly 14 are inclined and parallel to each other (as shown in FIG. 2 and FIG. 3). The first surface 1112A and the second surface 1122A are close to each other, clamping the moving element 113A, allowing the moving element 113A to move relative to the first surface 1112A and the second surface 1122A. The moving element 113A has only two contact points with the base assembly 13 and the first moving assembly 14.

As mentioned above, the base assembly 13 includes a base 131 and a first coil 132. The first coil 132 is disposed on the base 131, wherein the base 131 has an accommodation concave slot 1310. One recessed side wall of the accommodation concave slot 1310 has a first notch 1311 and the first coil 132 is located within the first notch 1311. The first moving assembly 14 includes a first moving body 141 and a first magnet 142. The first magnet 142 is disposed in the first moving body 141. The first moving body 141 has a first accommodation trough 1411 and the first magnet 142 is disposed in the first accommodation trough 1411. The location of the first notch 1311 corresponds to the location of the first accommodation trough 1411, aligning the first coil 132 with the first magnet 142. Furthermore, the magnetic pole direction of the first magnet 142 is arranged parallel to the first direction Z, with the S pole and the N pole of the magnetic pole oriented vertically. When a current passes through the first coil 132 and generates a corresponding magnetic field, the magnetic field of the first coil 132 interacts with the magnetic poles of the first magnet 142, causing the first moving assembly 14 to generate a pushing or pulling force relative to the base 131. Consequently, the first moving assembly 14, pressing against multiple moving element 113A, moves relative to the base 131. In other words, this drives the first moving assembly 14 to perform a reciprocating displacement in the first direction Z relative to the base 131. In some embodiments, above mentioned camera lens 12 is displaced by the first moving structure 11A, achieving the autofocus function of the camera structure 1.

In this embodiment, the camera structure 1 further includes a second moving assembly 15 and the moving structure 11 includes a second moving structure 11B. The second moving assembly 15 is disposed within the first moving assembly 14. The second moving structure 11B is located between the top portion of the first moving assembly 14 and the bottom portion of the second moving assembly 15, corresponding to the top portion of the first moving assembly 14. The first moving assembly 14 has a first moving portion 111B, and the second moving assembly 15 has a second moving portion 112B. The moving element 113B is located between the first moving portion 111B and the second moving portion 112B. The second moving structure 11B guides the second moving assembly 15 to perform a reciprocating movement in the second direction Y (i.e. the horizontal direction) relative to the first moving assembly 14. The second direction Y is perpendicular to the first direction Z.

As mentioned above, this embodiment includes three moving element 113B. The second moving assembly 15 has an L-shaped structure, with the three moving element 113B disposed at the two endpoints and the L-corner of the second moving assembly 15. The three moving element 113B form a movable, supporting horizontal plane and assembled between the second moving assembly 15 and the first moving assembly 14. Additionally, the second surface 1122B of the second moving portion 112B of the second moving assembly 15 are all is located at the inner side of the first surface 1112B of the first moving portion 111B of the first moving assembly 14 (as shown in FIG. 4), ensuring that the second moving assembly 15 is installed inside the inner side of the first moving assembly 14. The first surface 1112B of the first moving portion 111B of the first moving assembly 14 and the second surface 1122B of the second moving portion 112B of the second moving assembly 15 are inclined planes parallel to each other. The first surface 1112B and the second surface 1122B are close to each other, clamping the moving element 113B, and allowing the moving element 113B to move relative to the first surface 1112B and the second surface 1122B. The moving element 113B have only two contact points relative to the first moving assembly 14 and the second moving assembly 15.

In this embodiment, the camera structure 1 further includes a lens base assembly 16 and the moving structure 11 includes a third moving structure 11C. The lens base assembly 16 is disposed on the second moving assembly 15. The third moving structure 11C is located between the top portion of the second moving assembly 15 and the bottom portion of the lens base assembly 16, corresponding to the top portion of the second moving assembly 15. The second moving assembly 15 has a first moving portion 111C, and the lens base assembly 16 has a second moving portion 112C. The third moving structure 11C guides the lens base assembly 16 to perform reciprocating movement in the third direction X (i.e. the horizontal direction) relative to the second moving assembly 15. The third direction X is perpendicular to the second direction Y. Furthermore, the third direction X is perpendicular to the first direction Z.

As mentioned above, there are three moving element 113C in this embodiment. The second moving assembly 15 has an L-shaped structure, and the locations of the three moving element 113C correspond to the locations of the three moving element 113B. The three moving element 113C are similarly disposed at the two endpoints and the L-corner of the second moving assembly 15. The three moving element 113C form a movable, supporting horizontal plane and assembled between the second moving assembly 15 and the lens base assembly 16. Additionally, the first surface 1112C of the first moving portion 111C of the second moving assembly 15 are all located at the inner side of the second surface 1122C of the second moving portion 112C of the lens base assembly 16 (as shown in FIG. 5), ensuring that the second moving assembly 15 is installed inside the inner side of the lens base assembly 16. In other words, the second moving assembly 15 is ensured to be installed inside the location between the first moving assembly 14 and the lens base assembly 16, thereby ensuring the stability of the second moving assembly 15 during its movement relative to the first moving assembly 14 and the lens base assembly 16. Furthermore, the first surface 1112C of the first moving portion 111C of the second moving assembly 15 and the second surface 1122C of the second moving portion 112C of the lens base assembly 16 are inclined planes that parallel to each other. The first surface 1112C and the second surface 1122C are close to each other, clamping the moving element 113C, allowing the moving element 113C to move on the first surface 1112C and the second surface 1122C. The moving element 113C have only two contact points relative to the second moving assembly 15 and lens base assembly 16. Additionally, the camera lens 12 in this embodiment is installed on the lens base assembly 16, wherein the lens base assembly 16 has an assembly hole 160. The camera lens 12 can be fitted into the assembly hole 160, allowing the camera lens 12 to be driven and displaced through the base assembly 13, the first moving assembly 14, the second moving assembly 15, and the lens base assembly 16.

In this embodiment, the base assembly 13 includes a base 131 and a second coil 133. The second coil 133 is disposed on the base 131, wherein the recessed side wall of the accommodation concave slot 1310 of the base 131 further has a second notch 1312. The first notch 1311 and the second notch 1312 are located on different recessed side walls of the accommodation concave slot 1310. The second coil 133 is located within the second notch 1312. The lens base assembly 16 includes a lens base 161 and a second magnet 162, with the second magnet 162 disposed in the lens base 161. The lens base 161 has a second accommodation trough 1611 and the second magnet 162 is disposed within the second accommodation trough 1611. The location of the second notch 1312 corresponds to the location of the second accommodation trough 1611, ensuring that the second magnet 162 aligns with the second coil 133. The magnetic pole direction of the second magnet 162 is oriented parallel to the second direction Y; i.e., the S pole and the N pole of the magnetic pole are oriented in the horizontal direction. When a current passes through the second coil 133, the magnetic pole of the second coil 133 interact with the magnetic pole of the second magnet 162, causing the first moving assembly 14 to generate a pushing or pulling force relative to the base 131. Consequently, the lens base assembly 16 moves in the second direction Y through the second moving structure 11B between the second moving assembly 15 and the first moving assembly 14. More specifically, this drives the lens base assembly 16 and the second moving assembly 15 to perform reciprocating displacement relative to the first moving assembly 14 in the second direction Y.

Furthermore, base assembly 13 includes a base 131 and a third coil 134. The third coil 134 is disposed on the base 131, wherein the recessed side wall of the accommodation concave slot 1310 of the base 131 further has a third notch 1313. The first notch 1311, the second notch 1312, and the third notch 1313 are each located on different recessed side walls of the accommodation concave slot 1310. The third coil 134 is located within the third notch 1313. The lens base assembly 16 includes a lens base 161 and a third magnet 163. The third magnet 163 is disposed on the lens base 161, wherein the lens base 161 has a third accommodation trough 1612. The third magnet 163 is disposed within the third accommodation trough 1612. The location of the third notch 1313 corresponds to the location of the third accommodation trough 1612, ensuring that the third coil 134 aligns with third magnet 163 and the magnetic pole direction of the third magnet 163 are oriented in the third direction X. When a current passes through the third coil 134, the magnetic pole of the third coil 134 interacts with the magnetic pole of the third magnet 163, causing the first moving assembly 14 to generate a pushing or pulling force relative to the base 131. Consequently, the lens base assembly 16 moves in the third direction X through the third moving structure 11C. More specifically, this drives the lens base assembly 16 to perform reciprocating displacement relative to second moving assembly 15 in the third direction X. In some embodiments, above-mentioned camera lens 12 moves through the second moving structure 11B and the third moving structure 11C, thus providing the optical image stabilization function of the camera structure 1.

In this embodiment, the moving structure 11 includes a first moving structure 11A, a second moving structure 11B and a third moving structure 11C. The first moving structure 11A, the second moving structure 11B and the third moving structure C all have the same structure (as shown in FIG. 3). The first moving structure 11A is used for the reciprocating displacement in the first direction Z. The second moving structure 11B is used for the reciprocating displacement in the second direction Y. The third moving structure 11C is used for the reciprocating displacement in the third direction X. The purpose of above-mentioned moving structure 11 is to provide three-axis directional movement adjustment for the camera lens 12.

Please refer to FIG. 6, the camera structure 1 further includes a circuit board 17 disposed on the side surface of the base assembly 13. The circuit board 17 is located on the side surface of the first coil 132, of the second coil 133 and of the third coil 134. The circuit board 17 is electrically connected to the first coil 132, the second coil 133 and the third coil 134 respectively. Additionally, the camera structure 1 further includes a spring plate 18. The spring plate 18 is disposed on the first moving assembly 14 and presses against the top of the lens base assembly 16. The spring plate 18 is arranged along three sides of the first moving assembly 14, with edges of the spring plate 18 extending downward to form a fixing part 181. The first moving assembly 14 has a fixed trough 143 corresponding to the fixing part 181. The fixing part 181 of the spring plate 18 is fixed in the fixed trough 143 of the first moving assembly 14. The spring plate 18 can be used to constrain the lens base assembly 16 within the three sides of the first moving assembly 14. The spring plate 18 can be used to limit the movement range of the lens base assembly 16 and camera lens 12 in the first direction Z, and to ensure that the lens base assembly 16 remains properly assembled within the first moving assembly 14.

Furthermore, the camera structure 1 further includes a protective cover 19. The protective cover 19 has an orifice 191 and covers the base assembly 13, enclosing the first moving assembly 14, the second moving assembly 15, the lens base assembly 16, the circuit board 17, and the spring plate 18 within the base assembly 13. The camera lens 12 of the lens base assembly 16 extends through the orifice 191 of the protective cover 19.

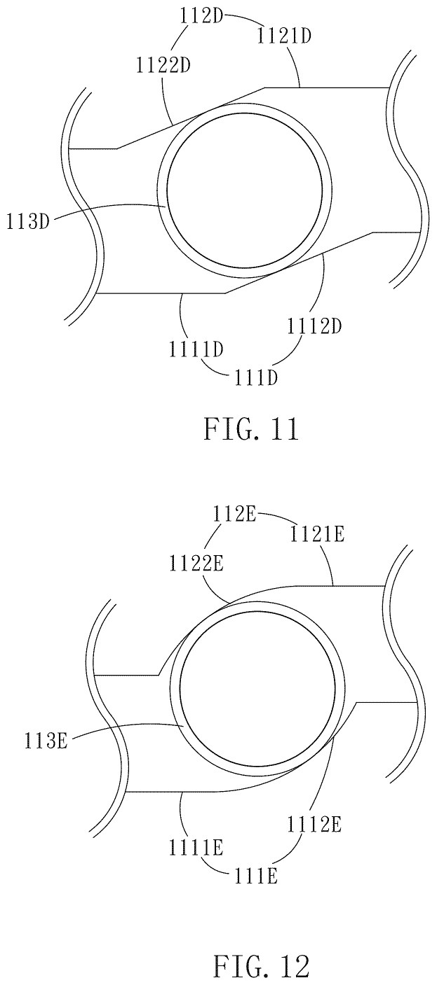

Please refer to FIG. 11, which is a schematic view of another embodiment of the moving structure of the present application. As shown in FIG. 11, the difference in this embodiment compared to the previously mentioned camera structure 1 lies in the included angles between the first surface of the first moving portion 111D and the second surface of the second moving portion 112D. In this embodiment, the first moving portion 111D includes a first plane 1111D and a first surface 1112D. The first plane 1111D extends to connect to the first surface 1112D. The first surface 1112D and the first plane 1111D have an included angle exceeding one hundred and twenty degree. The second moving portion 112D has a second plane 1121D and a second surface 1122D. The second plane 1121D extends to connect to the second surface 1122D. The second surface 1122D and the second plane 1121D has an included angle exceeding one hundred and twenty degree. The first plane 1111D is parallel to the second plane 1121D. This embodiment does not limit the included angles between the first plane 1111D and the first surface 1112D, nor between the second plane 1121D and second surface 1122D. The purpose is to ensure that the surface of the first surface 1112D and the surface of the second surface 1122D can mutually cooperate to clamp the moving element 113D, so that the moving element 113D only has two contact points with respect to the first moving portion 111D and the second moving portion 112D, thereby achieving the technical means and effects of this application.

Please refer to FIG. 12, which is a schematic view of yet another embodiment of the moving structure of the present application. As shown in FIG. 12, the difference in this embodiment compared to the previously mentioned camera structure 1 lies in the angles of the first surface of the first moving portion 111 and the second surface of the second moving portion 112. In this embodiment, the first moving portion 111E includes a first plane 1111E and a first surface 1112E. The first plane 1111E extends to connect to the first surface 1112E, which is a curved surface. The second moving portion 112E has a second plane 1121E and a second surface 1122E. The second plane 1121E extends to connect to the second surface 1122E, which is a curved surface. The center of the moving element 113E, relative to the contact points on the first surface 1112E and the second surface 1122E, forms a straight line, ensuring that the moving element 113E has only two contact points with first moving portion 111E and the second moving portion 112E. This achieves the technical means and effects of this application.

In summary, the present application provides a camera structure in which the moving element touches against the first surface of the first moving portion at the first contact point and moving element touches against the second surface of the second moving portion at the second contact point. The first contact point and second contact point are located on two sides of the moving element, allowing the moving element to move between the first surface of the first moving portion and the second surface of the second moving portion. In this embodiment, the moving element is assembled between the first moving portion and the second moving portion. The moving element is supported symmetrically by the contact points of the first moving portion and the second moving portion, which reduces sliding friction between the moving element and the first moving portion and the second moving portion. Thus, lowering the movement restrictions imposed by the first moving portion and the second moving portion on the moving element.

It should also be noted that the terms “comprise”, “includes” or any other variation thereof are intended to cover non-exclusive inclusion, so that a process, method, product, or apparatus that includes a list of elements not only includes those elements but may also include other elements not expressly listed or inherent to such process, method, product, or apparatus. Without additional limitations, an element defined by the phrase “including a . . . ” does not exclude the presence of additional identical elements in the process, method, product, or apparatus that includes the element.

The above description illustrates and describes several preferred embodiments of the present application. However, it should be understood that the present application is not limited to the forms disclosed herein and should not be construed as excluding other embodiments. It can be applied to various other combinations, modifications, and environments, and can be adapted within the scope of the inventive concepts presented here, based on the teachings provided or the knowledge and techniques in the relevant field. Any modifications and variations made by those skilled in the art that do not depart from the spirit and scope of the present application are intended to be within the scope of the appended claims.

What is claimed is:

1. A camera structure, comprising:
a moving structure, comprising a first moving portion, a second moving portion and a moving element, the moving element disposed between the first moving portion and the second moving portion, wherein the moving element is a sphere, the first moving portion has a first plane and a first surface, the first plane extending to connect to the first surface, the first surface and the first plane form an angle greater than ninety degrees, the second moving portion has a second plane and a second surface, the second plane extending to connect to the second surface, the second surface and the second plane form an angle greater than ninety degrees, the first plane parallel to the second plane, the moving element touches against the first surface at the first contact point, the moving element touches against the second surface at the second contact point, the first contact point and the second contact point is located at two sides of the moving element respectively, a line connecting the first contact point and the second contact point passes through a center of the moving element, the first moving portion and the second moving portion are configured to move relative to each other, the moving element is configured to move on the first surface and the second surface; and
a camera lens, configured to move through the moving structure.

2. The camera structure as claimed in claim 1, wherein the moving structure comprises a first protrusion and a second protrusion, the first protrusion protrudes from the first plane toward the second plane, the first surface is located on the first protrusion; the second protrusion protrudes from the second plane toward the first plane, and the second surface is located on the second protrusion.

3. The camera structure as claimed in claim 2, wherein the first protrusion comprises a first top surface, the second protrusion comprises a second top surface, the first top surface and the first plane are parallel to each other, and the second top surface and the second plane are parallel to each other.

4. The camera structure as claimed in claim 2, wherein the first protrusion comprises a first top surface, the second protrusion comprises a second top surface, the first top surface and the second plane are spaced apart from each other, and the second top surface and the first plane are spaced apart from each other.

5. The camera structure as claimed in claim 4, wherein a minimum distance between the first top surface and the second plane is less than the diameter of the moving element, and a minimum distance between the second top surface and the first plane is less than the diameter of the moving element.

6. The camera structure as claimed in claim 1, wherein the camera structure further comprises a base assembly and a first moving assembly, the first moving assembly is located within the base assembly, the moving structure comprises a first moving structure, the first moving structure is provided between an inner wall of the base assembly and an outer wall of the first moving assembly, the base assembly has the first moving portion, the first moving assembly has the second moving portion, the first moving structure is configured to guide the first moving assembly to perform a reciprocating movement in a first direction relative to the base assembly.

7. The camera structure as claimed in claim 6, wherein the base assembly comprises a base and a first coil, the first coil disposed on the base, the first moving assembly comprises a first moving body and a first magnet, the first magnet is disposed on the first moving body, the first coil corresponds to the first magnet, and a magnetic pole direction of the first magnet is parallel to the first direction.

8. The camera structure as claimed in claim 7, wherein the base has an accommodation concave slot, a recessed side wall of the accommodation concave slot has a first notch, the first coil is located in the first notch, the first moving body has a first accommodation trough, the first magnet is disposed in the first accommodation trough, and a location of the first notch corresponds to a location of the first accommodation trough.

9. The camera structure as claimed in claim 6, further comprising a second moving assembly, wherein the moving structure comprises a second moving structure, the second moving assembly is disposed within the first moving assembly, the second moving structure is provided between a top portion of the first moving assembly and a bottom portion of the second moving assembly, the first moving assembly has the first moving portion, the second moving assembly has the second moving portion, the second moving structure is configured to guide the second moving assembly to perform a reciprocating movement in a second direction relative to the first moving assembly, and the second direction is perpendicular to the first direction.

10. The camera structure as claimed in claim 9, further comprising a lens base assembly, wherein the moving structure comprises a third moving structure, the lens base assembly is disposed on the second moving assembly, the third moving structure is provided between a top portion of the second moving assembly and a bottom portion of the lens base assembly, the second moving assembly has the first moving portion, the lens base assembly has the second moving portion, the third moving structure is configured to guide the lens base assembly to perform a reciprocating movement toward a third direction relative to the second moving assembly, and the third direction perpendicular to the second direction.

11. The camera structure as claimed in claim 10, wherein the camera lens is disposed on the lens base assembly.

12. The camera structure as claimed in claim 10, wherein the base assembly comprises a base and a second coil, the second coil is disposed on the base, the lens base assembly comprises a lens base and a second magnet, the second magnet is disposed on the lens base, the second magnet corresponds to the second coil, and a magnetic pole direction of the second magnet is parallel to the second direction.

13. The camera structure as claimed in claim 12, wherein the base has an accommodation concave slot, a recessed side wall of the accommodation concave slot further has a second notch, the second coil is located in the second notch, the lens base has a second accommodation trough, the second magnet is disposed in the second accommodation trough, and a location of the second notch corresponds to a location of the second accommodation trough.

14. The camera structure as claimed in claim 10, wherein the base assembly comprises a base and a third coil, the third coil is disposed on the base, the lens base assembly comprises a lens base and a third magnet, the third magnet is disposed on the lens base, the third magnet corresponds to the third coil, and a magnetic pole direction of the third magnet parallel to the third direction.

15. The camera structure as claimed in claim 14, wherein the base has an accommodation concave slot, a recessed side wall of the accommodation concave slot further comprises a third notch, the third coil is located in the third notch, the lens base has a third accommodation trough, the third magnet is disposed in the third accommodation trough, a location of the third notch corresponds to a location of the third accommodation trough.

16. The camera structure as claimed in claim 10, further comprising a spring plate, wherein the spring plate is disposed on the first moving assembly, and the spring plate presses against a top of the lens base assembly.

17. The camera structure as claimed in claim 16, wherein the spring plate is arranged along a side of the first moving assembly, and a fixing part extends downward from an edge of the spring plate, the first moving assembly has a fixed trough corresponding to the fixing part, and the fixing part of the spring plate is correspondingly fixed in the fixed trough of the first moving assembly.

18. The camera structure as claimed in claim 1, further comprising a circuit board, wherein the circuit board is arranged around the base assembly, and the circuit board is electrically connected to the first coil, the second coil and the third coil respectively.

19. The camera structure as claimed in claim 1, wherein the first surface is parallel to the second surface, and the first plane and the second plane are inclined planes or correspondingly curved surfaces.
